(19) United States
(12) Patent Application Publication
(10) Pub. No.: US 2012/0006280 A1
(43) Pub. Date: Jan. 12, 2012

(54) Weatherized Pet House

(75) Inventor: Daniel Gray, Tallassee, AL (US)

(73) Assignee: TBB Enterprises LLC, Auburn, AL (US)

(21) Appl. No.: 12/830,880

(22) Filed: Jul. 6, 2010

(51) Int. Cl. A01K 1/03

(52) U.S. Cl. 119/500

(57) ABSTRACT

A weatherized pet house including means for supplying HVAC from a building for keeping the air in the pet house at desirable levels in hot or cold weather which in turn keeps water drinkable in a water dish inside the structure.

### BACKGROUND

Most pet houses remain primitive structures with four walls and a roof in which the air is virtually the same temperature and humidity as the outside environment. Usually these pet houses, however, are in close proximity to a modern residence with a surplus of HVAC. Because pet houses are much smaller than a residence it would be desirable to connect the pet house to a residence in such a way to provide HVAC service to the pet house. The average residence in the U.S. is approximately 2000 square feet with 8 foot ceilings, or 16,000 cubic feet. The HVAC for this size structure can accommodate providing HVAC to a small pet house whose dimensions rarely exceed 3 feet×4 feet by 3 feet, or 36 cubic feet. Average residence size in some areas or in other countries could be smaller, but would still be vastly larger than the size of the average pet house. The extra cost for HVAC for the residence would be minimal and the benefits to the pet's environment would be enormous. Besides the outside pet's ability to escape the heat or cold to a more livable temperature, another major benefit would be achieved if the pet's water dish were moved inside the pet house, thus keeping the water at a more desirable temperature in these seasons.

Several methods of providing HVAC to a pet house have been attempted, but there is not a pet house commercially available which solves all the problems of providing HVAC treated air to a pet house. Each of these previous efforts is either too complicated and expensive or unworkable, as indicated in part by the lack of commercial success of any of these prior efforts. The prior art demonstrates confusion over how to go about providing a pet house which shields outside pets from extremes of weather but in a way that is simple and inexpensive enough to be consumer friendly. Most outside pet owners want their pets to be free of temperature extremes, but they also do not want to spend much money or time on a complicated structure while doing so. The prior art includes pet houses with technically feasible solutions, perhaps, but which cost more than consumers are willing to spend, or are far more complicated to install or maintain than most consumers are able or willing to tolerate.

Thus, there is a need for simple, inexpensive and effective means for making a pet house livable year round in most weather environments.

### SUMMARY

The invention is a pet house whose only opening to the outdoors is a door occluded by flaps or similar material allowing free passage for the pet, but also retaining air inside the pet house when the pet is not using the door. The only other opening is an inlet from an HVAC vent which connects to a residence serviced by HVAC. The HVAC vent connects to the residence through a sliding window by means of a window panel which is inserted into the sliding window when it is partially-opened. The window panel has an outlet through which HVAC-treated air leaves the residence and travels through the HVAC vent to the pet house. In one embodiment the outlet is equipped with a moveable barrier which can be opened or closed from inside the residence by hand or by an electronic motor communicating with a thermostat inside the pet house. A water dish inside the pet house also solves the problem of keeping water at a desirable temperature in hot and cold seasons.

### BRIEF DESCRIPTION OF THE DRAWINGS

FIG. 1 is a perspective view of the invention from outside the residence. In this embodiment, the internal water dish is filled from the outside by means of a port on the outside of an exterior wall.

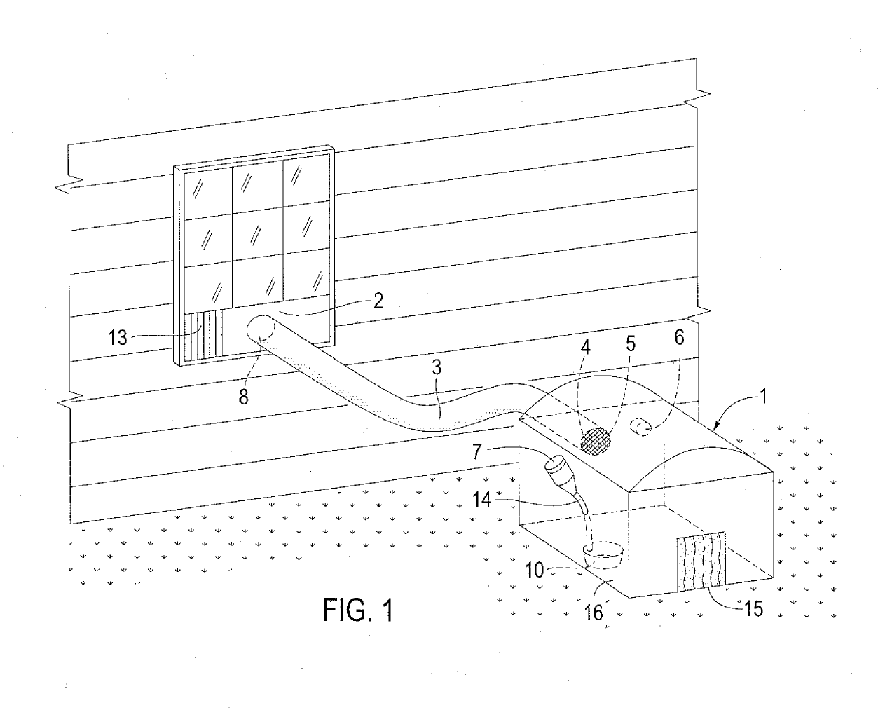

FIG. 2 is a perspective view of an embodiment of the moveable barrier as a motor driven damper, with the motor on the inside of the window panel. The damper is in a partially opened position.

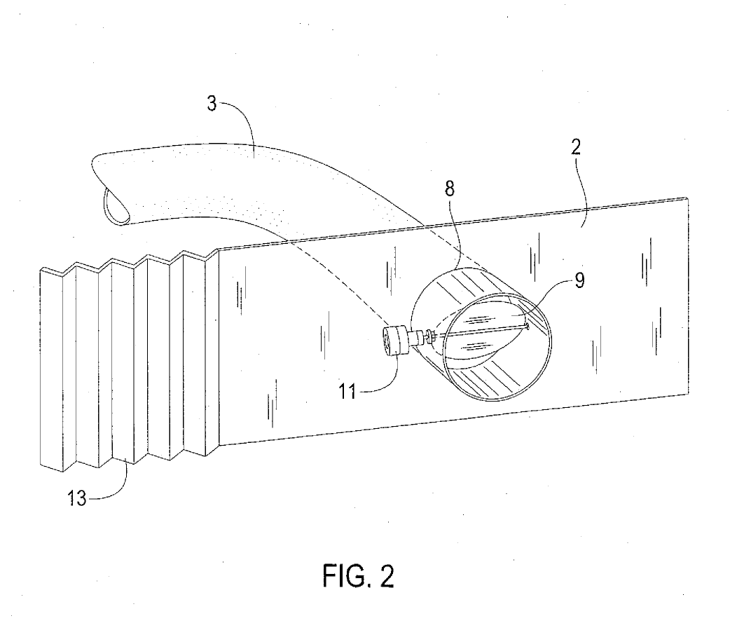

FIG. 3 is a perspective view of an alternate embodiment of the water dish and how it is inserted through the side of the pet house structure, showing it with a handle for insertion and a tongue and groove to secure it in place.

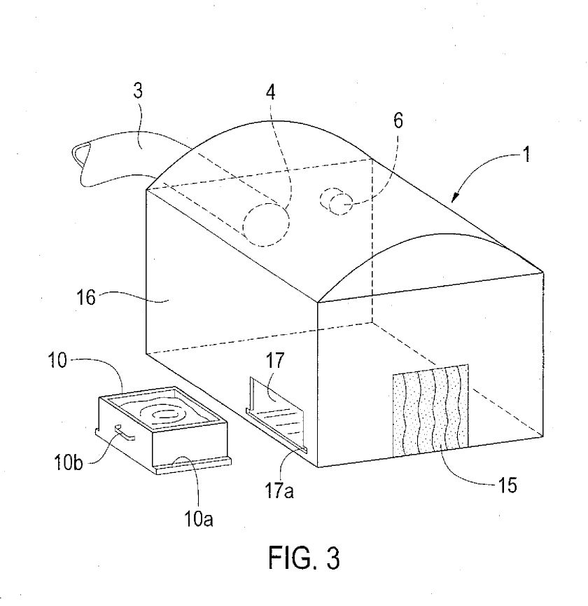

### DETAILED DESCRIPTION

Many pet houses have openings to the outside such as vents which make it impossible to regulate the temperature inside. In hot and cold months, regulation of the temperature in the invention, therefore, requires the only opening to the outside be occluded, in one embodiment, by a set of flaps 15 which occlude the opening but allow free passage for the pet. The flaps 15 hanging down from the top of the opening may be constructed of neoprene or other material, and retain the inside air except when the pet moves through the door. Optional vents or windows on the exterior walls may be provided, as long as they can be sealed tightly when the weather is hot or cold.

The only opening besides the door in the invention is an inlet 4 connected to an HVAC vent 3. A first end of the HVAC duct 3 is connected tightly to the inlet 4 and a second end is connected tightly to an outlet 8 in a window panel 2 which is installed in a partially opened sliding window. The HVAC vent 3 is, in one embodiment, flexible tubing or piping with or without insulation. The HVAC vent 3 can also be rigid tubing or piping. The window panel 2 can be turned horizontally or vertically to fit windows sliding in either direction and has an adjustable boot 13 to allow it to fit most residential sliding windows. In one embodiment there is no moveable barrier at the outlet so that heat flows continuously until the temperatures of the HVAC building and the pet house equilibrate. In another embodiment, the outlet 8 in the window panel 2 is covered by a moveable barrier 9 which is, in one embodiment, a damper which opens by hand or, in another embodiment, opens automatically by means of an electric motor 11 when the temperature in the pet house 1 is either cooler or warmer than the setting of a thermostat 6 situated in the pet house. In other embodiments, the moveable barrier 9 covering the outlet 8 can be shutters, doors, curtains or any other device which can be opened or closed optionally.

In one embodiment, when the air temperature in the pet house 1 reaches a desired temperature set on a thermostat 6 inside the pet house, the moveable barrier 9 positioned in the outlet opens and allows the HVAC-treated air to move out through the HVAC vent 3 to the pet house 1. An electric motor 11, connected to a power source, is activated to open or close the moveable barrier 9 in the outlet 8 according to the temperature setting on the thermostat 6. In one embodiment, the power supply is a solar cell 10 which is attached to the window panel 2.

In the embodiment with a thermostat 6 and electric motor 11 for automatic temperature control, there is a cold weather mode and a warm weather mode. The thermostat 6 communicates with the electric motor 11, in one embodiment, by a wire routed through the HVAC vent or, in another, by means of wireless components. In cold weather mode, the moveable barrier is shut when the temperature in the pet house is equal to or greater than the thermostat setting, but otherwise the moveable barrier stays open. In warm weather mode, the moveable barrier 9 is shut when the temperature in the pet house 1 is less than or equal to the setting on the thermostat 6, but otherwise the moveable barrier 9 stays open.

The natural phenomenon of passive heat flow means that heat transfers from a hotter to a colder substance. That is, heat in air dissipates naturally and passively without the necessity of a specific pump or fan to move air. For example, in cold months a heated home has a surplus of heated air compared to the outdoors, and heat will naturally flow out of an open door or window. Likewise, during hot months heat will move into a cool house through an open window or door. The HVAC vent in the present invention will serve as such an opening to draw heat to the pet house in the cold season, even without a pump or fan, and the heat transfer will be stopped by the occluding flaps 15. Likewise, in the hot season when the air inside the pet house becomes hotter than the air inside the building which is being cooled, heat will flow out the HVAC vent toward the cooler building, without the need for a pump or fan. Optionally there can be more than one location for the inlet 4 so that in hot months, when heat rises in the pet house, the HVAC vent can be attached on top of the structure but, when it is cold outside, the inlet 4 can be located near the floor to better heat it. A movable cap for the two inlets can be switched back and forth from season to season.

In one embodiment the electric motor 11 is positioned on the inside of the window panel 2, so as to eliminate the need for protection from the elements. The electric motor 11 can be mounted on the outside of the window panel 2 if it is properly protected from the weather. The electric motor 11 engages the moveable barrier 9 and causes it to open or shut. A power cord from the electric motor 11 is plugged into a wall outlet in the interior of the residence. Alternatively, the electric motor 11 can be driven by a battery or by solar panels affixed to the window panel 2.

The HVAC vent 3 optionally contains a mesh screen 5 to prevent bug entry into the residence.

In one embodiment, the pet house 1 can be insulated so as to minimize the need for

HVAC from the building. Insulation for the outer roof, walls and floor may be added in one embodiment to increase the efficiency of equilibrating the temperature in the pet house with the HVAC building.

In another embodiment, windows in the pet house 1 allow sunlight through glass panes or clear plastic such as Lexann.

A problem closely related to the problem of ambient air temperature for the outside pet is that of water. In hot months the water in the dish is hot but is cold in cold months. Bringing the water dish 10 inside the pet house with HVAC, however, means the water in the dish is maintained at a more desirable temperature. In one embodiment the water can be poured in through a channel 14 which opens to the outside and is covered by a cap. In another embodiment, the water dish 10 is inserted into an exterior wall 16 of the pet house so that one side of the water dish 10 forms part of the exterior wall 16 of the pet house. In the latter embodiment, the water dish 10 resembles a drawer with a handle 10b and can be held in place by means of a tongue 10a on and a groove 17a in an opening 17 in the exterior wall 16.

What is claimed is:

1. A weatherized pet house, comprising
a. a floor, a roof and walls,
b. a door through one of the walls to the outdoors, said door being occluded by flaps which allow the pet passage in and out of the pet house, and
c. an inlet connected to an HVAC vent having a first end connected to the pet house and a second end connected to a building with HVAC,
such that heat flows passively between the building with HVAC and the pet house.

2. The weatherized pet house as in claim 1, further comprising the second end of the HVAC vent connected to the building through a sliding window.

3. The weatherized pet house as in claim 2, further comprising the second end of the HVAC vent connected with the building at an outlet in a window panel placed in the sliding window of the residence.

4. The weatherized pet house as in claim 3, further comprising the window panel being of adjustable width.

5. The weatherized pet house as in claim 3, further comprising a moveable barrier inserted in the outlet.

6. The weatherized pet house as in claim 4, in which the moveable barrier inserted in the outlet is selected from the group consisting of louvers, shutters, doors and curtains.

7. The weatherized pet house as in claim 5, further comprising
a. a thermostat on the inside of the pet house, said thermostat being in communication by wire or wirelessly with an electric motor, and
b. the electric motor which opens and closes the moveable barrier,
such that the moveable barrier is opened or closed according to the settings on the thermostat.

8. The weatherized pet house as in claim 1, further comprising a mesh screen covering the inlet.

9. The weatherized pet house as in claim 7, further comprising a power supply which is one of or a combination of AC, a battery or a solar cell.

10. The weatherized pet house as in claim 1, further comprising insulation for the pet house or the HVAC vent.

11. The weatherized pet house as in claim 1, further comprising a water dish on the inside of the pet house, having means for filling the water dish from outside the pet house.

12. The water dish in the weatherized pet house as in claim 11, in which the means for filling the water dish from outside the pet house further comprises a slideable drawer whose outer wall forms part of the exterior wall of the pet house.

13. The water dish in the weatherized pet house as in claim 11, in which the means for filling the water dish from outside the pet house further comprises an exterior opening and a conduit from the exterior opening leading to the water dish.
